(19) United States
(12) Patent Application Publication
(10) Pub. No.: US 2004/0008212 A1
(43) Pub. Date: Jan. 15, 2004

(54) Reshaping irregularly-shaped images for improved compression

(75) Inventor: Thomas G. O'Neill, Mountain View, CA (US)

Correspondence Address: David B. Ritchie, THELEN REID & PRIEST LLP, P.O. Box 640640, San Jose, CA, 95164-0640, US

(73) Assignee: Sun Microsystems, Inc., a Delaware Corporation

(21) Appl. No.: 10/319,048

(22) Filed: Dec. 13, 2002

Related U.S. Application Data
(63) Continuation-in-part of application No. 10/194,123, filed on Jul. 11, 2002.
(63) Continuation-in-part of application No. 10/247,907, filed on Sep. 20, 2002.

(51) Int. Cl. G09G 5/00; G06T 11/20

(52) U.S. Cl. 345/628; 345/441; 345/622

(57) ABSTRACT

A solution is provided to reshape irregularly-shaped computer graphics images in order to reduce the number of rectangles generated for transmission. It may be used any time it is useful to compress a set of digital image data from an irregularly-shaped region of pixels. A post-shaping process may be utilized wherein rectangles in a destination window are examined and any touching (or possibly nearby) rectangles are merged into a single rectangle. Alternatively, a pre-shaping process may be utilized wherein images drawn with a single command are merged into a single rectangle. Each of these processes has advantages and disadvantages which may make one or the other preferable, depending upon the circumstances. Additionally, both processes may be used together if desired.

### CROSS-REFERENCE TO RELATED APPLICATION

The present application is a continuation-in-part of co-pending application Ser. No. 10/194,123, filed on Jul. 11, 2002, by Thomas G. O'Neill and Jordan M. Slott, entitled “TAGGING MULTICOLOR IMAGES FOR IMPROVED COMPRESSION”, attorney docket no. SUN-P7082 and of co-pending application Ser. No. 10/247,907, filed on Sep. 20, 2002, by Thomas G. O'Neill and Jordan M. Slott, entitled “TAGGING SINGLE COLOR IMAGES FOR IMPROVED COMPRESSION”, attorney docket no. SUN-P7083, herein incorporated by reference.

### FIELD OF THE INVENTION

The present invention relates to the field of computer graphics. More particularly, the present invention relates to the reshaping of irregularly-shaped images in order to improve compression.

### BACKGROUND OF THE INVENTION

Remote computing applications where screen information is generated on one computer (a “host”) and transmitted for display on another computer (“a display”) are growing in popularity. Examples of some display computers include multipurpose PCs, thin-clients, and Personal Digital Assistants (PDAs).

The X Windows System is a standard that utilizes X client software and X server software to enable the updating of displays at the requests of X client applications. The X server software runs on the host computer. An X client application, which may be running on a different computer, communicates with the X server software by utilizing a low-level library of routines known as Xlib. Xlib provides the functions required to connect to display servers, create windows, render graphics, respond to events, etc. The X server software then may interface with display drivers to actually render the graphics on the display.

X is frequently used as a “local display application”, where the X-server and display are both on the same computer. That is, the same computer is both the “host” and “display” computer. Examples of this usage include running an X-server on a workstation or on an X-terminal. An X-terminal typically has a computer processor, graphics subsystem and display, but no hard drive. Applications running on other computers use the Xlib routines to communicate with the X-server software running on the X-terminal.

While in some contexts it is advantageous to have the X server and the display on the same computer, this is not necessarily the case in other contexts. One specific context that will be discussed is a remote display application. In such a design, client applications make requests of a centralized server or servers (here known collectively as the “host computer”). The host computer then manages one or more “display computers”, which are typically simple terminal devices.

The Sun Ray™ appliance from Sun Microsystems, Inc. of Palo Alto, Calif. is an example of a thin client which serves as a “display computer” in a remote computing application. A Sun Ray™ appliance has a processor, graphics subsystem and display, but no hard drive. A Sun Ray™ appliance is a “display” computer and runs its own proprietary software. The Sun Ray™ server is the “host” computer and runs the X-server software. The full screen image is maintained both in RAM on the host computer as well as in the frame buffer of the Sun Ray™ appliance's video card. In order to synchronize the displays, the host computer sends screen update information to the Sun Ray™ appliance via a network protocol known as NewT. The Sun Ray™ appliance uses the protocol commands to update the state of its hardware frame buffer.

In remote display applications, an increased burden is placed on the network as more information is transmitted from the host computer to the display computers. It is desirable to reduce network bandwidth used by remote computing applications. Doing so provides shorter transmission times between the host and display computers, reduced load on the network (and resulting improvement in network performance), and the capability to utilize more devices on a single network.

For many typical computing functions such as web browsing, the image updates sent from the host computer to the display computer may include irregularly-shaped images. For example, logos or buttons placed on a web page may not be perfectly rectangular. In order to easily mesh with a large number of background colors, these images are often created such that the shape of the image to be drawn on the screen exactly matches the shape of the logo or button (as opposed to having a background color contained in the image in order to make it rectangular).

In many remote display architectures, each protocol command specifies an image update for a single screen rectangle. Thus, transmission of these irregularly-shaped images requires splitting them into rectangles and transmitting each rectangle individually. For example, a circular logo may be transmitted as several hundred individual rectangles. However, the more rectangles transmitted, the more CPU time and bandwidth utilized. Additionally, if an RGB codec is used, its performance may be limited. This is because RGB codecs often boost compression by use of spacial coherency, which operates on the principle that pixels tend to have values similar to nearby pixels. These similar pixels may then be correlated and compressed. However, if the image is broken into smaller rectangles, there are fewer pixels within each rectangle to correlate. Furthermore, some types of RGB codecs, known as block-based codecs, also suffer additional performance reductions when many rectangles are utilized. Block-based codecs divide an image into tiles and compress each tile individually in order to improve memory usage. These tiles are typically fixed-sized (e.g., 8×8 pixel blocks). Thus, it is possible that the codec may need to encode a significant amount of fake data if the rectangle to be transmitted is smaller than the block dimension. E.g., if a block-based codec is used on a rectangle whose height is less than the block size, the encoder must encode a region equal to the full height of the block, and the decoder discards the extra rows of pixel data. Obviously, the transmission of fake data wastes CPU time and bandwidth.

What is needed is a solution for efficiently transmitting an irregularly-shaped image to the display computer.

### BRIEF DESCRIPTION

A solution is provided to reshape irregularly-shaped computer graphics images in order to reduce the number of rectangles generated for transmission. It may be used any time it is useful to compress a set of digital image data from an irregularly-shaped region of pixels. A post-shaping process may be utilized wherein rectangles in a destination window are examined and any touching (or possibly nearby) rectangles are merged into a single rectangle. Alternatively, a pre-shaping process may be utilized wherein images drawn with a single command are merged into a single rectangle. Each of these processes has advantages and disadvantages which may make one or the other preferable, depending upon the circumstances. Additionally, both processes may be used together if desired.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram illustrating a remote display application such as a Sun Ray™ network.

FIG. 2 is a diagram illustrating example executions of various embodiments of the present invention.

FIG. 3 is a flow diagram illustrating a method for pre-shaping one or more source graphics regions in accordance with an embodiment of the present invention.

FIG. 4 is a flow diagram illustrating a method for post-shaping a graphics region, the graphics region including rectangles, in accordance with an embodiment of the present invention.

FIG. 5 is a flow diagram illustrating a method for post-shaping a graphics region, the graphics region including rectangles, in accordance with another embodiment of the present invention.

FIG. 6 is a block diagram illustrating an apparatus for pre-shaping one or more source graphics regions in accordance with an embodiment of the present invention.

FIG. 7 is a block diagram illustrating an apparatus for post-shaping a graphics region, the graphics region comprising one or more rectangles, in accordance with an embodiment of the present invention.

FIG. 8 is a block diagram illustrating an apparatus for post-shaping a graphics region, the graphics region comprising one or more rectangles, in accordance with another embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention provides a mechanism to reshape irregularly-shaped image in order to reduce the number of rectangles generated for transmission. As will be seen, this results in the ability to dramatically reduce CPU and network bandwidth utilization without affecting image quality. The present application can be used any time it is useful to compress a set of digital image data from an irregularly-shaped region of pixels. An irregularly-shaped image may be defined as one that requires a large number of rectangles to describe. This solution may be used in conjunction with identifying and handling single-color images and identifying and handling multicolor images and miscellaneous images, but does not have to be. The reduction of the number of rectangles alone will result in CPU and bandwidth savings.

Some examples of cases where the invention could be used include saving images created in a pixel-based drawing program to compressed data files, or compression of a region of screen data for transmission from the host computer to the display computer in a remote computing application. For purposes of illustration, this disclosure focuses on remote display applications where the host computer runs an X-server. However, one of ordinary skill in the art will recognize that the invention could be applied to any application wishing to compress irregularly-shaped image data.

This disclosure also focuses on the reshaping of RGB images since these frequently dominate the overall bandwidth and are a common type of irregularly-shaped images. Here an “RGB image” may be defined as one that is rendered from a list of pixel values (as opposed to, for example, an image rendered from a specification of a geometric figure or text characters). In the X-server, such images are created using the XPutImage command.

In remote display applications based on an X server, the Device Dependent X (DDX) layer of the X server may be modified to include possible compression of the screen data and transmission of remote display protocol commands to the display computer. The DDX provides a software interface to a conceptual hardware device. In a specific embodiment of the present invention, the desired results can be accomplished by modifying the DDX, without changing the Device Independent X (DIX) layer.

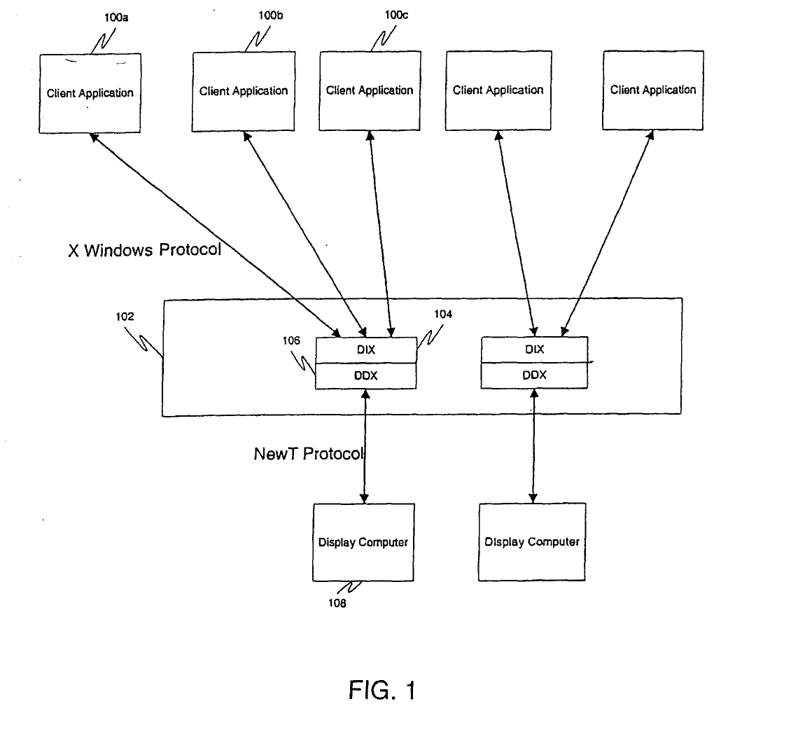

FIG. 1 is a block diagram illustrating a remote display application such as a Sun Ray™ network. Client applications 100a-100c send information to and receive information from the host computer 102 over the X Windows Protocol. The host computer utilizes a device independent layer (DIX) 104 to act as a controlling layer, which handles initialization procedures and all device-independent handling of requests and events. A device dependent layer (DDX) 106 then is used to handle device dependent functionality. The DDX 106 then communicates with display computer 108 using the NewT protocol. The DIX and the DDX essentially make up an X-server.

The X-server allows the client application to draw to either off-screen pixmaps or to windows (which can appear on-screen), collectively referred to as “drawables”. Both window and pixmap drawables comprise rectangular pixel regions. An RGB image can be created in a drawable either directly via an XPutImage command or indirectly by using XCopyArea to copy to the drawable a portion of a pixmap that itself contains an RGB image. Both the XPutImage and XCopyArea commands render to individual destination rectangles. Although the drawables and destination regions are rectangles, a client application can create an irregularly-shaped RGB image through the use of the client clipping region in the graphics context. The client can clip the RGB image to an irregular shape during the XPutImage or the XCopyArea command. Or it can draw a regularly-shaped RGB image and make it irregular by overwriting part of it with an irregularly-shaped opaque fill region using a clipped XPolyFillRect command.

Consider the simplest case of XPutImage of an RGB image directly to a realized (onscreen) window. In one embodiment of the present invention, the RGB region may be reshaped whenever the RGB image requires more than one rectangle to describe. In another embodiment, the RGB region may be reshaped when the number of rectangles is greater than or equal to a threshold number of rectangles and greater than or equal to a threshold fraction times the height of the RGB region. Either approach works well if the reshaping requires a relatively small amount of CPU usage. In one embodiment of the present invention, the reshaped RGB region may be calculated solely from the irregularly shaped RGB region. This may be known as “post-shaping”.

A sample post-shaping process follows. Let regIrr be the original irregularly-shaped region and regNew be the new region. Let boxNew be the first rectangle in regIrr. Loop over the other rectangles in regIrr (in the YX banded order in which X stores the rectangles of regions). If one of these rectangles touches boxNew on the right or the bottom, increase boxNew to the bounding box of boxNew and the new rectangle. Thus, the third rectangle in regIrr can be found to touch boxNew even if it doesn't touch the first rectangle in regIrr. After the loop over rectangles, the rectangle boxNew is added to the regNew region and subtracted from regIrr. If regIrr is not empty, then boxNew is set to its first rectangle and the loop over rectangles is repeated. The process continues until regIrr is empty.

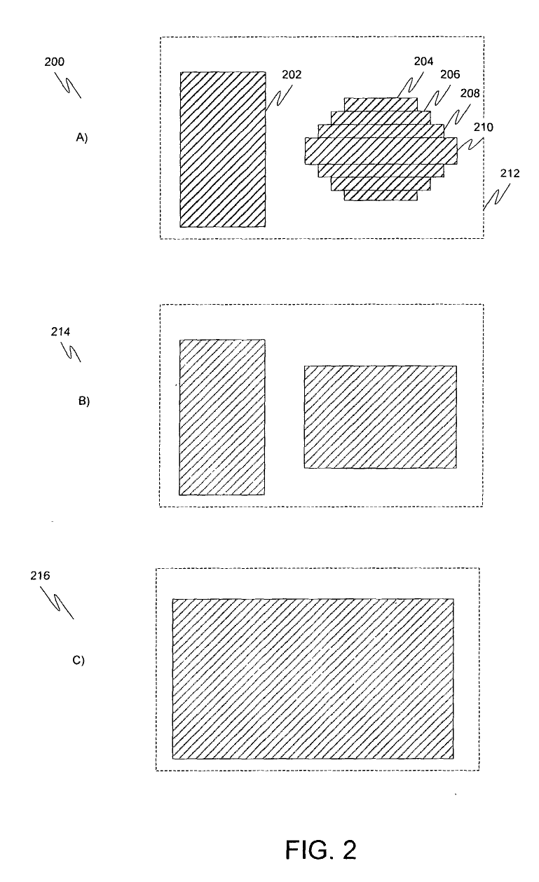

FIG. 2 is a diagram illustrating example executions of various embodiments of the present invention. Case A 200 represents an example where each of the rectangles 202, 204, 206, 208, 210 were drawn with a single XPutImage command (either to a pixmap or to a window) with a destination rectangle denoted by the dashed line 212. Here, an attempt is made to draw a rectangle and an (approximate) circle. Because the resulting RGB region is irregularly shaped, it takes several rectangles to represent.

Post-shaping the rectangles in case A may result in case B 214. This illustrates the fact that the process may not be able jump to gaps to connect disconnected but related RGB regions. This may be suboptimal in cases where, for example, a speckled RGB region is created, such as the toolbar minimizing buttons on the left side of the Navigation and Location Toolbars in Netscape. This may be altered by allowing the post-shaping process to combine rectangles that are nearby but not touching. This may be illustrated by case C 216, where all the rectangles, being close together, are combined into a single rectangle.

It should be clear that there is a good deal of freedom in the design of the post-shaping process. For example, one could develop heuristics to avoid cases where merging the rectangles would worsen compression by turning a low-area irregular image region into a high-area regular region. Nevertheless, all post-shaping processes can easily merge RGB rectangles that were created with different XPutImage commands. If these images contain very different types of image data, combining them would lead to worse compression. This problem can be worsened if post-shaping is utilized to merge rectangles that are merely nearby in an attempt to avoid the problem illustrated in case B of FIG. 2.

An alternative approach would be to decide that the entire RGB region created by a single XPutImage command is part of a single logically-related image that should be compressed as a single rectangle. This may be termed the “pre-shaping” process. In one embodiment, the rectangle is simply the destination rectangle used in the XPutImage command. In another embodiment, the rectangle is found as the bounding box of the composite-clipped RGB region, which is also illustrated by case C 216 of FIG. 2 (the composite clip region is found by applying both the client clip region and clipping by other windows). This has the advantage of sometimes finding a rectangle that is smaller than the destination rectangle, for example, if another window is on top of part of the RGB image. Unlike the post-shaping process, the pre-shaping process will not merge unrelated images that happen to be touching.

Although the pre-shaping process is free of the disadvantages listed for the post-shaping process, it may have disadvantages of its own. As illustrated in case C of FIG. 2, it may result in larger RGB regions. This typically does not hurt the bandwidth because the additional area is frequently single-color and compresses efficiently. Nevertheless, it can lead to additional host computer CPU usage if the RGB compression techniques are CPU-intensive.

In one embodiment, the pre- and post-shaping processes can be combined to minimize the disadvantages of each. The pre-shaping technique may be used to identify all of the logically-related rectangles and then the post-shaping technique may be used only on logically-related rectangles, merging those that meet whatever heuristics are deemed optimal. In practice, the pre- and post-shaping techniques work well enough on their own that their combination often remains unnecessary.

In X, a region resource may be used to describe an arbitrarily shaped piece of real estate in XY pixel space. I.e, it can be used to describe an arbitrary collection of pixels by characterizing their XY positions. In X, the positions are characterized by an array of rectangles for which every pixel is in the region. This representation is efficient for regularly-shaped regions, which occur frequently in X, but inefficient for regions with a lot of isolated pixels, which occur much less frequently in X. The rectangle representation is also very convenient for remote display applications such as Sun Ray™, where each protocol command specifies the screen update for a single screen rectangle.

X provides a series of routines for performing set operations (union, subtraction, intersection, etc.) on the region resources, which are very convenient in the practice of the invention. The region resources and routines were originally developed to assist with the computation of clipping and drawn-to regions. The composite clip list for a drawable (window or pixmap) represents the region that can currently be drawn to. It includes the effects of clipping requested by the client application (the client clip list) and, if the drawable is a window, by other windows that are on top of the window in question. The drawn-to region for a particular DDX command is found by intersecting the composite clip list with the region that the command would render in the absence of clipping. It is this region to which the command actually renders.

In X, an irregularly-shaped RGB region can be created in several ways:

1. XPutImage directly to a realized window using an irregularly-shaped client clipping region.

2. XPutImage to a pixmap using an irregularly-shaped client clipping region.

3. XPutImage to a pixmap using a regularly-shaped client clipping region, followed by an XCopyArea of the pixmap to another pixmap or window using an irregularly-shaped client clipping region.

4. XPutImage to a pixmap using a regularly-shaped client clipping region, followed by an opaque XPolyFillRect to the pixmap using an irregularly-shaped client clipping region.

5. XPutImage to a window using a regularly shaped client clipping region, followed by an opaque XPolyFillRect to the window using an irregularly-shaped client clipping region.

Embodiments will be described in relation to cases 3 and 4. Cases 1 or 2 appear to be rare in practice, and no special treatment is typically required for irregular shaped created via case 5—the regularly-shaped RGB image will be compressed and sent when the XPutImage occurs, then the irregularly-shaped fill commands will be compressed and sent afterwards.

Cases 2-4 are situations where the original RGB image is not drawn directly to the screen, but only become visible (if ever) upon an XCopyArea to a realized window. Practicing the invention when the XCopyArea is performed requires a method of identifying which portions of the drawn-to region contains RGB images, This can be done by looking for many-colored regions in the destination window. But the prefered implementation is to determine the location of the RGB sub-images from the sequence of drawing commands used to draw the pixmap image. For example, an X region resource known as the “RGB region” can be associated with the pixmap to track the location of the RGB sub-images within the pixmap image. When an XPutImage command is executed to the pixmap, its drawn-to regions are is added to the RGB region. When an opaque PolyFillRect is executed to the pixmap, its drawn-to region is removed from the RGB region. The RGB region of the XCopyArea source rectangle, translated to destination coordinates and intersected with the composite clip list, yields the RGB portion of the drawn-to region.

Such implementations are easier for the post-shaping technique as irregularly-shaped RGB images created via cases 3 and 4 are only made visible by the XCopyArea of a pixmap to a realized window. Thus it may be sufficient to apply the post-shaping only in the DDX CopyArea routine, and then only when the destination drawable is a realized window.

By contrast the pre-shaping technique must never allow the RGB region of a pixmap to become irregular, because it cannot regularize the region after he fact. Thus pre-shaping requires modification of two DDX routines: CopyArea (to handle case 3) and PolyFillRect (to handle case 4). The heart of the pre-shaping technique may be a function reshape_region which takes two main arguments: the source RGB region and the clipped RGB region. For each rectangle in the source RGB region, the routine may find the bounding box of its intersection with the clipped RGB region. The union of these bounding boxes is the reshaped RGB region.

For CopyArea to a pixmap, the source RGB region is the RGB-tagged region of the source pixmap, translated to the destination pixmap's coordinates. The reshaped RGB region may then be added to the RGB region tag of the destination pixmap. For CopyArea to a realized window, the RGB-tagged region of the source pixmap may instead be translated to the screen coordinates. The reshaped region may then be compressed and sent via a compression algorithm designed for use on RGB images. For PolyFillRect to a pixmap, the source RGB region is the original RGB-tagged region of the destination pixmap and the “clipped” RGB region is the region after subtraction of the clipped fill region. If the invention is used along with single-color image tagging, then the reshaped RGB region may be subtracted from the pixmap's fill region to prevent overlap between the RGB and fill regions (this also makes the fill region more regularly-shaped, ultimately leading to fewer fill protocol commands).

There is some flexibility in the treatment of the clipping by other windows. In one embodiment, the window clipping may be treated on equal footing with the client clipping, and the reshaped region can include that part of an overlapping window which obscures part of the RGB image. In another embodiment the reshaping is performed using one of the above-described techniques, and then the reshaped region is clipped with the window clipping region. The latter is the better practice because the pixel values in the overlapping window are clearly unrelated to and have no spatial coherency with those in the RGB image, so including the overlapping window would worsen compression. The alternative treatment would only be better in pathological situations where a single RGB image is overlapped by multiple small windows.

In the present application, an embodiment of the present invention is described in the context of a modification of traditional X Windows technology for use with remote computing applications. However, one of ordinary skill in the art will recognize that other embodiments are possible and the present invention should not be limited to X Windows, Sun Ray™, or remote computing technology.

While XPutImage is a specific command in the X Windows System, the term put image command may be used in the present application to refer to any rendering command used to create an RGB image.

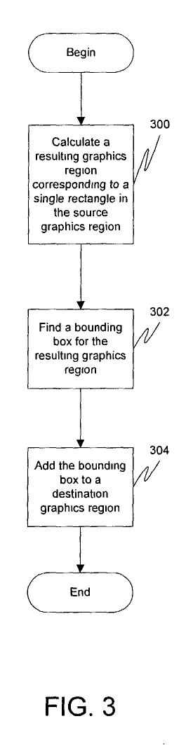

FIG. 3 is a flow diagram illustrating a method for pre-shaping a resulting graphics region in accordance with an embodiment of the present invention. This method may be repeated for each rectangle in a source graphics region and may be performed upon receipt of a command creating or copying an RGB image or images. If the command is a put image command, the source graphics region may be a rectangle defined in call parameters. If the command is a copy area command, the source graphics region may be a region (e.g., the RGB region) of a source pixmap translated to destination coordinates. If the command is a PolyFillRect command, the source graphics region may be a region (e.g., the RGB region) of a destination drawable before the command is applied. At 300, a resulting graphics region corresponding to a single rectangle in the source graphics region may be calculated. The resulting graphics region may be calculated by applying the command to the source graphics rectangle (e.g., if the command is PolyFillRect). It may also include intersecting this rectangle with a clip region (e.g., commands other than PolyFillRect). Or, equivalently, it may include intersecting this rectangle with the graphics region corresponding to the full source graphics region. At 302, a bounding box for the resulting graphics region may be found. The bounding box may be defined by choosing the smallest rectangle that would completely surround the desired graphic. At 304, the bounding box may be added to a destination graphics region. The destination graphics region therefore accumulates the bounding boxes resulting from each rectangle in the source graphics region.

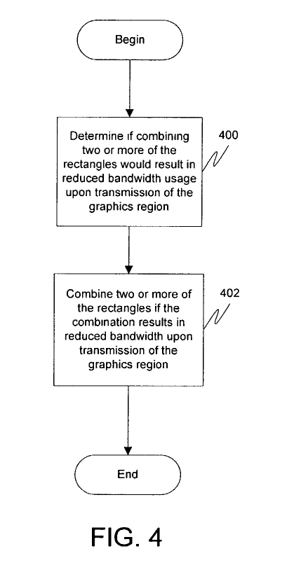

FIG. 4 is a flow diagram illustrating a method for post-shaping a graphics region, the graphics region comprising one or more rectangles, in accordance with an embodiment of the present invention. At 400, it may be determined if combining two or more of the rectangles in the region would result in reduced bandwidth usage upon transmission of the graphics region. This determining may include using a typical cost per pixel in bandwidth usage and a typical cost per rectangle in bandwidth usage to arrive at a predicted cost for a first rectangle, a second rectangle, and a rectangle bounding the first rectangle and the second rectangle. At 402, if the combination results in reduced bandwidth usage upon transmission of the graphics region, then two or more of the rectangles may be combined. This combining may include combining the first rectangle and the second rectangle if a sum of the predicted cost for the first rectangle and the second rectangle is greater than or equal to the predicted cost for the region bounding the first rectangle and the second rectangle.

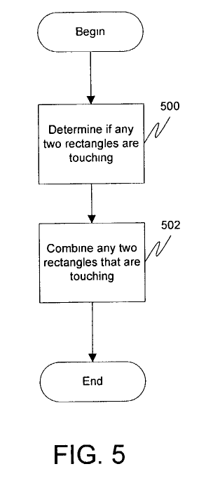

FIG. 5 is a flow diagram illustrating a method for post-shaping a graphics region, the graphics region comprising one or more rectangles, in accordance with another embodiment of the present invention. At 500, it may be determined if any two rectangles are touching. In another embodiment, it may also determined if they are nearby. Nearby may be defined as a preset number of pixels. Alternatively, nearby may be defined as a preset distance proportional to the areas of the rectangles. At 502, any two rectangles that are touching (or nearby, if desired) may be combined.

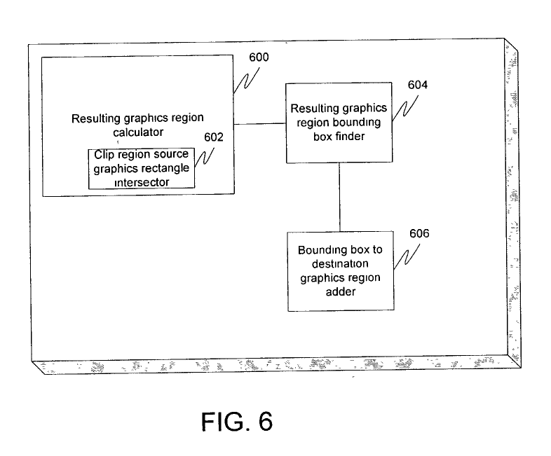

FIG. 6 is a block diagram illustrating an apparatus for pre-shaping a resulting graphics region in accordance with an embodiment of the present invention. The apparatus may iterate for each rectangle in a source graphics region and may be performed upon receipt of a command creating or copying an RGB image or images. If the command is a put image command, the source graphics region may be a rectangle defined in call parameters. If the command is a copy area command, the source graphics region may be a region of a source pixmap translated to destination coordinates. If the command is a PolyFillRect command, the source graphics region may be a region of a destination pixmap before the command is applied. A resulting graphics region calculator 600 may calculate a resulting graphics region corresponding to a single rectangle of the source graphics region. The resulting graphics region may be calculated by applying the command to a single rectangle in the source graphics region. It may also include intersecting this rectangle with a clip region using a clip region source graphics rectangle intersector 602. A resulting graphics region bounding box finder 604 coupled to the resulting graphics region calculator 600 may find a bounding box for the resulting graphics region. The bounding box may be defined by choosing the smallest shape that would completely surround the desired graphic. A bounding box to destination graphics region adder 606 coupled to the resulting graphics region bounding box finder 604 may add the bounding box to a destination graphics region.

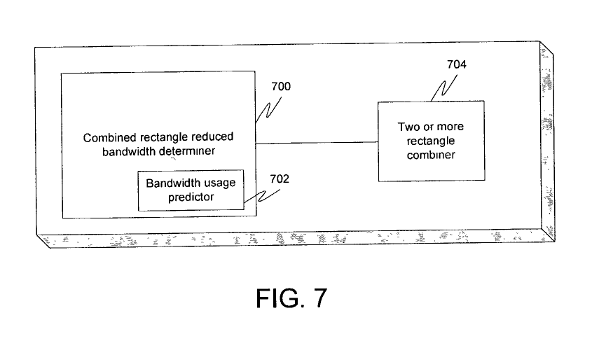

FIG. 7 is a block diagram illustrating an apparatus for post-shaping a graphics region, the graphics region including rectangles, in accordance with an embodiment of the present invention. A combined rectangle reduced bandwidth determiner 700 may determine if combining two or more of the rectangles would result in reduced bandwidth usage upon transmission of the graphics region. This determining may include using a typical cost per pixel in bandwidth usage and a typical cost per rectangle in bandwidth usage to arrive at a predicted cost for a first rectangle, a second rectangle, and a region combining the first rectangle and the second rectangle using a bandwidth usage cost predictor 702 capable of receiving a typical cost per pixel and cost per rectangle in bandwidth usage. A two or more rectangle combiner 704 coupled to the combined rectangle reduced bandwidth determiner 700 may combine two or more of the rectangles if the combination results in reduced bandwidth usage upon transmission of the graphics region. This combining may include combining the first rectangle and the second rectangle if a sum of the predicted cost for the first rectangle and the second rectangle shaped region is greater than or equal to the predicted cost for the region combining the first rectangle and the second rectangle.

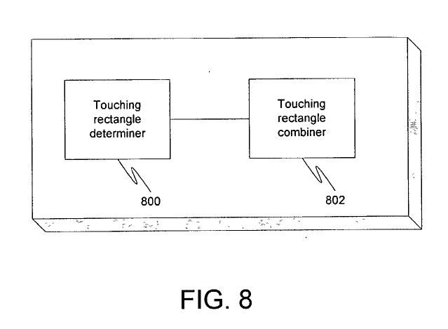

FIG. 8 is a block diagram illustrating an apparatus for post-shaping a graphics region, the graphics region including rectangles, in accordance with another embodiment of the present invention. A touching rectangle determiner 800 may determine if any two rectangles are touching. In another embodiment it may also determine if they are nearby. Nearby may be defined as a preset number of pixels. Alternatively, nearby may be defined as a preset distance proportional to the areas of the rectangles. A touching rectangle combiner 802 coupled to the touching rectangle combiner 802 may combine any two rectangles that are touching (or nearby).

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for pre-shaping a resulting graphics region, comprising:
determining the source graphics region, said source graphics region comprising one or more rectangles;
for each rectangle in said source graphics region:
calculating a resulting graphics region corresponding to said rectangle;
finding a bounding box for said resulting graphics region; and
adding said bounding box to a destination graphics region.

2. The method of claim 1, wherein said method is performed upon receipt of command creating or copying an RGB image or images.

3. The method of claim 2, wherein said resulting graphics region is a graphics region formed by applying said command.

4. The method of claim 2, wherein said source graphics region is a rectangle defined in call parameters if said command is a put image command.

5. The method of claim 2, wherein said source graphics region is a region of a source pixmap translated to destination coordinates if said command is a copy area command.

6. The method of claim 2, wherein said source graphics region is a region of a destination pixmap before said command is applied if said command is a PolyFillRect command.

7. The method of claim 1, wherein said calculating includes intersecting a clip region with said source graphics region.

8. The method of claim 1, wherein said bounding box is a region created by choosing the smallest shape that would completely surround the desired graphic.

9. A method for handling a put image command defining a source graphics region, wherein the source graphics region is a rectangle defined in call parameters, the method comprising the following for each rectangle in the source graphics region:
calculating a resulting graphics region corresponding to said source graphics region;
finding a bounding box for said resulting graphics region; and
adding said bounding box to a destination graphics region.

10. The method of claim 9, wherein said bounding box is a region created by choosing the smallest shape that would completely surround the desired graphic.

11. The method of claim 9, wherein said calculating includes intersecting a clip region with said source graphics region.

12. A method for handling a copy area command defining a source graphics region, wherein the source graphics region is a region of a source pixmap translated to destination coordinates, the method comprising the following for each rectangle in the source graphics region:
calculating a resulting graphics region corresponding to said source graphics region;
finding a bounding box for said resulting graphics region; and
adding said bounding box to a destination graphics region.

13. The method of claim 12, wherein said bounding box is a region created by choosing the smallest shape that would completely surround the desired graphic.

14. The method of claim 12, wherein said calculating includes intersecting a clip region with said source graphics region.

15. A method for handling a PolyFillRect command defining a source graphics region, wherein the source graphics region is a region of a destination pixmap before said PolyFillrect command is applied, the method comprising the following for each rectangle in the source graphics region:
calculating a resulting graphics region corresponding to said source graphics region;
finding a bounding box for said resulting graphics region; and
adding said bounding box to a destination graphics region.

16. The method of claim 15, wherein said bounding box is a region created by choosing the smallest shape that would completely surround the desired graphic.

17. The method of claim 15, wherein said calculating includes intersecting a clip region with said source graphics region.

18. A method for post-shaping a graphics region, said graphics region including rectangles, the method comprising:
determining if combining two or more of said rectangles would result in reduced bandwidth usage upon transmission of said graphics region; and
combining two or more of said rectangles if said combination results in reduced bandwidth usage upon transmission of said graphics region.

19. The method of claim 18, wherein said determining comprises:
using a typical cost per pixel in bandwidth usage and a cost per rectangle in bandwidth usage to arrive at a predicted cost for a first rectangle, a second rectangle, and a region combining said first rectangle and said second rectangle.

20. The method of claim 19, wherein said combining comprises:
combining said first rectangle and said second rectangle if a sum of said predicted cost for said first rectangle and said second rectangle is greater than or equal to the predicted cost for said region combining said first rectangle and said second rectangle.

21. A method for post-shaping a graphics region, said graphics region including rectangles, the method comprising:
determining if any two rectangles are touching; and
combining any two rectangles that are touching each other.

22. The method of claim 21, further comprising:
determining if any two rectangles are nearby each other; and
combining any two rectangles that are nearby each other.

23. The method of claim 22, wherein two rectangles are nearby if they are within a preset number of pixels from each other.

24. The method of claim 22, wherein two rectangles are nearby if they are within a preset distance proportional to their areas.

25. A method for reducing the memory used to store or transmit a graphics image in a computer system, comprising:
recording a put image command executed to create a portion of the graphics image in a pixmap;
for each rectangle in said pixmap:
calculating a resulting graphics region corresponding to said rectangle;
finding a bounding box for said resulting graphics region;
adding said bounding box to a destination graphics region;
using said put image command to update a data structure associated with said pixmap with information; and
compressing one or more sub-images of the graphics image using a compression scheme, each of said sub-images having a location, said location and said compression scheme for each of said sub-images chosen based on said information in said data structure.

26. The method of claim 25, wherein said data structure associated with said pixmap is a series of partially-transparent overlap layers.

27. The method of claim 25, wherein said data structure associated with said pixmap identifies the portion of the pixmap image that corresponds to a reshaped destination region for a specific drawing command.

28. The method of claim 27, wherein said data structure associated with said pixmap is a bitmask identifying which pixels are in said reshaped destination region for a specific drawing command.

29. The method of claim 27, wherein said data structure associated with said pixmap is a list of rectangles specifying which pixels are in said reshaped destination region for a specific drawing command.

30. The method of claim 25, wherein said compression scheme is an RGB codec.

31. A method for reducing the memory used to store or transmit a graphics image in a computer system, comprising:
adding a drawn-to region to an RGB region when a put image command is executed;
for each rectangle in said RGB region:
calculating a resulting graphics region corresponding to said rectangle;
finding a bounding box for said resulting graphics region;
adding said bounding box to a destination graphics region;
compressing said destination graphics region using a compression scheme, said compression scheme optimized for use with RGB images.

32. The method of claim 31, further comprising intersecting said RGB region with a clip region before said compressing.

33. The method of claim 31, further comprising storing said RGB region in an RGB-tagging structure

34. The method of claim 33, wherein said storing comprises storing said RGB region as a list of rectangles in an RGB-tagging data structure.

35. A method for reducing the memory used to store or transmit a graphics image in a computer system, comprising:
recording a put image command executed to create a portion of the graphics image in a pixmap;
using said put image command to update a data structure associated with said pixmap with information;
determining if any two rectangles in said pixmap are touching;
combining any two rectangles that are touching each other; and
compressing one or more sub-images of the graphics image using a compression scheme, each of said sub-images having a location, said location and said compression scheme for each of said sub-images chosen based on said information in said data structure.

36. The method of claim 35, wherein said data structure associated with said pixmap is a series of partially-transparent overlap layers.

37. The method of claim 35, wherein said data structure associated with said pixmap identifies the portion of the pixmap image that corresponds to a reshaped destination region for a specific drawing command.

38. The method of claim 37, wherein said data structure associated with said pixmap is a bitmask identifying which pixels are in said reshaped destination region for a specific drawing command.

39. The method of claim 37, wherein said data structure associated with said pixmap is a list of rectangles specifying which pixels are in said reshaped destination region for a specific drawing command.

40. The method of claim 35, wherein said compression scheme is an RGB codec.

41. A method for reducing the memory used to store or transmit a graphics image in a computer system, comprising:
adding a drawn-to region to an RGB region when a put image command is executed;
removing a drawn-to region from said RGB region when an opaque fill command is executed;
determining if any two rectangles in said RGB region are touching each other;
combining any two rectangles that are touching each other; and
compressing said RGB region using a compression scheme, said compression scheme optimized for use with RGB images.

42. The method of claim 41, further comprising intersecting said RGB region with a clip region before said compressing.

43. The method of claim 41, further comprising storing said RGB region in an RGB-tagging structure

44. The method of claim 43, wherein said storing comprises storing said RGB region as a list of rectangles in an RGB-tagging data structure.
